(19) United States
(12) Patent Application Publication
(10) Pub. No.: US 2026/0065916 A1
(43) Pub. Date: Mar. 5, 2026

(54) ARTIFICIAL INTELLIGENCE POWERED DEEPFAKE DETECTION FILTERING PIPELINE

(71) Applicant: Palo Alto Networks, Inc., Santa Clara, CA (US)

(72) Inventors: Lucas Mingyuan Hu, Palo Alto, CA (US); William Russell Melicher, Sunnyvale, CA (US); Mohamed Yoosuf Mohamed Nabeel, San Jose, CA (US); Oleksii Starov, Sunnyvale, CA (US); Wei Wang, Milpitas, CA (US)

(21) Appl. No.: 18/818,811

(22) Filed: Aug. 29, 2024

(51) Int. Cl. G10L 17/26; G10L 17/02; H04L 9/40

(52) U.S. Cl. CPC G10L 17/26; G10L 17/02; H04L 63/1483

(57) ABSTRACT

A filtering pipeline has been created that filters videos/audios for deepfake detection. The filtering pipeline applies a series of filtering operations that begins with filtering video/audio based on contextual content, such as keywords on a webpage proximate to a URL that links to the media). The filtering pipeline then filters based on voice detection and obtains transcripts for the remaining videos. Topic-based filtering is performed with the transcripts. If media has not been filtered out, then the filtering pipeline prompts a LLM to classify the media as promoting misleading information based on the transcript. If media has not been filtered out, then deepfake detection is run on the media.

### BACKGROUND

The disclosure generally relates to data processing and computing arrangements based on computational models (e.g., CPC subclass G06N and CPC subclass G06F 16).

Rapid developments in artificial intelligence (AI) technologies have spawned numerous terms with fluid meanings. AI technologies are frequently referred to with the terms large language model (LLM), generative AI, and foundation model. Many of these technologies are based on or relate to the “Transformer”architecture.

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data.

Some LLMs are based on the Transformer architecture. An LLM is “large” because the training parameters are typically in the billions and have been approaching a trillion parameters. AI technologies are not limited to LLMs and research and utilization of “lightweight”language models (i.e., fewer parameters than large) has grown.

Language models can be pre-trained to perform general-purpose tasks or tailored to perform specific tasks. Tailoring of language models can be achieved through various techniques, such as prompt engineering and fine-tuning.

While generative AI technologies can have positive impacts, they have also been misused. One type of misuse is the synthesis of “deepfakes.” The term deepfake is a portmanteau of “deep” from deep learning and “fake” because the synthesized content is fake. A deepfake is usually a video, but can be other media, such as an image or audio. A deepfake misrepresents someone as doing or saying something that was not actually done or said by that person, who is typically a celebrity or public figure. While fake media has been created in the past with editing software, the fake media created with generative AI models are significantly more convincing.

### BRIEF DESCRIPTION OF THE DRAWINGS

Embodiments of the disclosure may be better understood by referencing the accompanying drawings.

FIG. 1 is a diagram of a deepfake detection filtering pipeline powered with a foundation model.

FIG. 2 is a flowchart of example operations for filtering media for deepfake detection with a filtering pipeline that includes context based filtering.

FIG. 3 is a flowchart of example operations for filtering media for deepfake detection with a filtering pipeline that does not include context based filtering.

FIG. 4 is a flowchart of example operations for filtering media for deepfake detection with a filtering pipeline that uses celebrity/public figure analysis for deepfake detection.

FIG. 5 is a flowchart of example operations for celebrity/public figure analysis for deepfake detection.

FIG. 6 depicts an example computer system with a deepfake detection filtering pipeline.

### DESCRIPTION

The description that follows includes example systems, methods, techniques, and program flows to aid in understanding the disclosure and not to limit claim scope.

Well-known instruction instances, protocols, structures, and techniques have not been shown in detail for conciseness.

### Terminology

This description uses the term “misleading information” to encompass the variety of information used to mislead people for the purpose of deception or fraud, typically for financial gain (e.g., scamming or phishing). Misleading information includes misinformation, disinformation, and malinformation. Misinformation is false information, not necessarily with harmful intent but can cause harm. Disinformation is false information intended to cause harm and/or manipulate. Malinformation is information that is based in fact but exaggerated to mislead.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Deepfake detection is computationally expensive, especially when scanning multimedia (e.g., video). When using a third-party service for deepfake detection, that computational expense because a large expense. A cybersecurity service provider scans millions of webpages per day. Those millions of web page scans can include scanning hundreds of thousands of videos. Assuming a cost of $0.10 to $1.00 per scan by a deepfake detection vendor, the cybersecurity service provider can incur millions of dollars of expense per month. A cybersecurity service provider cannot pass that huge expense to customers and cannot absorb that cost. For other types of organizations that host or present a larger scale of videos (e.g., content providers and social media companies), the problem is at a larger scale even if as an internalized expense.

In addition to the financial burden, the complexity of deepfake detection results in an approximate accuracy rate of 95%, which can have cost in terms of false positives. At a scale of 100,000 videos scanned in a day, thousands of those videos will be incorrectly indicated as deepfakes. An organization that incorrectly blocks or labels thousands of videos per day will suffer a negative impact on its reputation and possibly face legal consequences.

A filtering pipeline has been created that filters videos for deepfake detection to concentrate deepfake detection on a smaller set of videos that facilitates a lower false positive rate while conserving resources. The filtering pipeline applies a series of filtering operations that begins with filtering video/audio based on contextual content, such as keywords on a webpage proximate to a URL that links to the video/audio (hereinafter “media”). The filtering pipeline then filters based on voice detection and obtains transcripts for the remaining videos. Topic-based filtering is performed with the transcripts. If media has not been filtered out, then the filtering pipeline prompts a foundation model or LLM to classify the media as promoting misleading information based on the transcript. If media has not been filtered out, then deepfake detection is run on the media. The filtering pipeline can be implemented with a URL scanning/filtering service to filter out URLs from deepfake detection. The filtering pipeline can also be implemented as part of an application or platform that examines videos being uploaded to the platform or web-based application prior to allowing the video to be streamed or downloaded.

### Example Illustrations

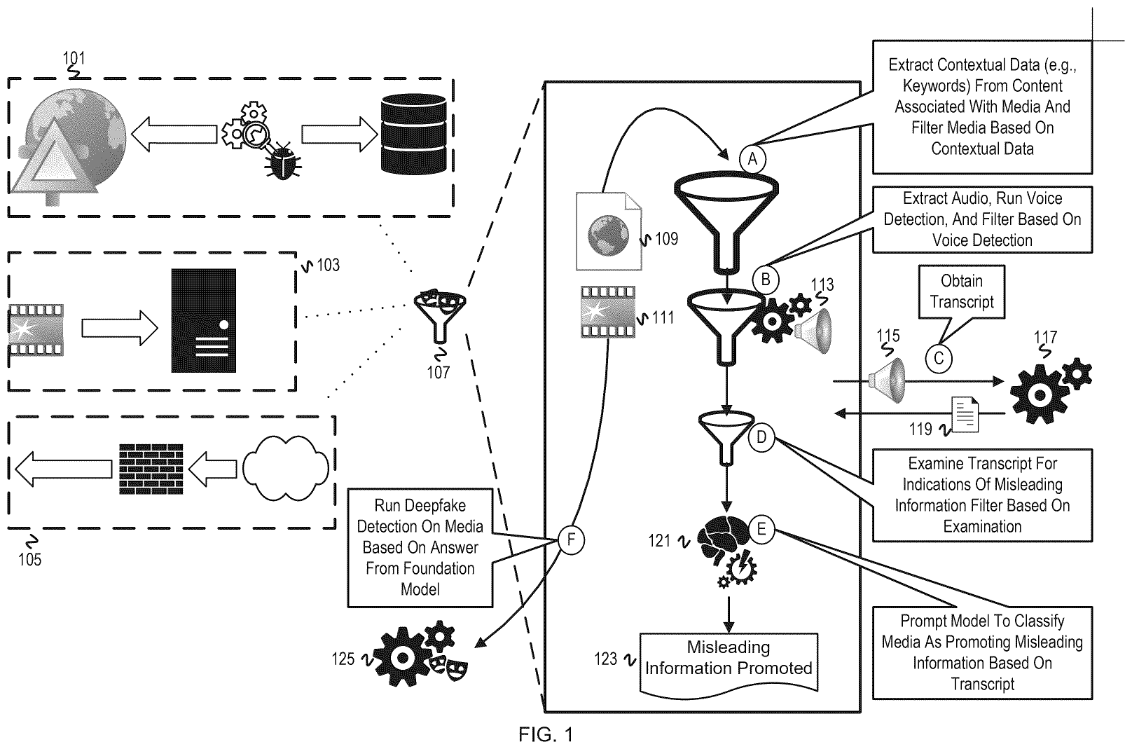

FIG. 1 is a diagram of a deepfake detection filtering pipeline powered with a foundation model. A deepfake detection filtering pipeline 107 is depicted as being incorporated into or running in conjunction with any one or more of multiple deployment scenarios 101, 103, 105. The different deployment scenarios are depicted to provide context and should not be used to limit use of the disclosed technology. A single instance of the deepfake detection filtering pipeline 107 is depicted, but a different instance can be used for each of the different deployment scenarios. The deployment scenario 101 is depicted as a URL filtering service that submits to the deepfake detection filtering pipeline 107 URLs of webpages that have embedded media or links to media. Although they can be submitted individually, batches of URLs with embedded or linked media can be submitted to the deepfake detection filtering pipeline 107. The deployment scenario 105 is a firewall that performs inline URL filtering and submits a URL or webpage with embedded or linked media to the deepfake detection filtering pipeline 107. The deployment scenario 103 is a service or platform that allows media to be uploaded to servers. Prior to acceptance of media or prior to allowing public access of the media, the media is submitted to the deepfake detection filtering pipeline 107. Media that is not filtered out by the deepfake detection filtering pipeline 107 will be analyzed for deepfake detection.

FIG. 1 is annotated with a series of letters A-F representing stages of operations with each stage representing one or more operations. Although these stages are ordered for this example, the stages illustrate one example to aid in understanding this disclosure and should not be used to limit the claims. Subject matter falling within the scope of the claims can vary from what is illustrated.

At stage A, the deepfake detection filtering pipeline 107 extracts contextual data (e.g., keywords) from content 109 associated with media 111 and filters the media 111 from deepfake detection based on the contextual data. The deepfake detection filtering pipeline 107 receives a webpage or webpage URL with the media 111 embedded or linked within the webpage from one of the one of the deployment scenarios 101, 103, 105. The deepfake detection filtering pipeline 107 extracts tags, source descriptions, text sections, etc., from the content 109. The content 109 may be a webpage with text and tags that describe the media 111, source code of the webpage, or metadata associated with the media 111 in a descriptor file or database entry. The deepfake detection filtering pipeline 107 maintains a list of keywords correlated with misleading information correlated with scams or malicious campaigns. If none of the keywords are detected, then the media 111 is filtered out from deepfake detection. If any of the keywords are detected, then the media continues through the deepfake detection filtering pipeline 107. While the media 111 is mentioned when describing stage A, embodiments do not necessarily download or retrieve the media 111 until stage B. Embodiments can perform the stage A filtering with the content 109 and avoid retrieving the media 111 if none of the misleading information keywords are detected.

At stage B, the deepfake detection filtering pipeline 107 filters based on voice detection. The deepfake detection filtering pipeline 107 extracts audio 115 from the media 111 (assuming the media 111 is video and not audio) and runs a voice detection service 113 on the audio 115. The voice detection service 113 can be incorporated within the deepfake detection filtering pipeline 107 or can be an external application or service invoked by the deepfake detection filtering pipeline 107. If a voice (i.e., a human voice) is detected, then the media 111 continues through the deepfake detection filtering pipeline 107.

At stage C, the deepfake detection filtering pipeline 107 obtains a transcript of the audio 115. The deepfake detection filtering pipeline 107 uses a service 117 to transcribe the audio 115 and generate a transcript 119. As with the voice detection service 113, the transcription service 117 can be incorporated into the deepfake detection filtering pipeline 107 instead of an external service.

At stage D, the deepfake detection filtering pipeline 107 filters the media 111 based on the transcript 119. The deepfake detection filtering pipeline 107 examines the transcript 119 for indications of misleading information. The deepfake detection filtering pipeline 107 can employ one or more techniques/technologies for this examination. For example, the deepfake detection filtering pipeline 107 can determine sentiment or topic of the transcript with machine-learning based natural language processing (NLP) or generative artificial intelligence (AI). If no indications of misleading information are detected, then the media 111 is filtered out from deepfake detection.

At stage E, the deepfake detection filtering pipeline 107 leverages a foundation model to determine whether the media 111 promotes misleading information based on the transcript 119. For instance, the deepfake detection filtering pipeline 107 prompts a foundation model 121 to classify the media 111 as promoting misleading information based on the transcript 119. The deepfake detection filtering pipeline 107 constructs a prompt with the task instruction to classify the media 111 as promoting misleading information and incorporates the transcript 119 into the prompt.

At stage F, the deepfake detection filtering pipeline 107 runs deepfake detection on the media 111 based on an answer 123 from the foundation model 121. If the answer 123 classified the media 111 as promoting misleading information, then the deepfake detection filtering pipeline 107 submits the media 111 to a deepfake detection service 125 to run deepfake detection.

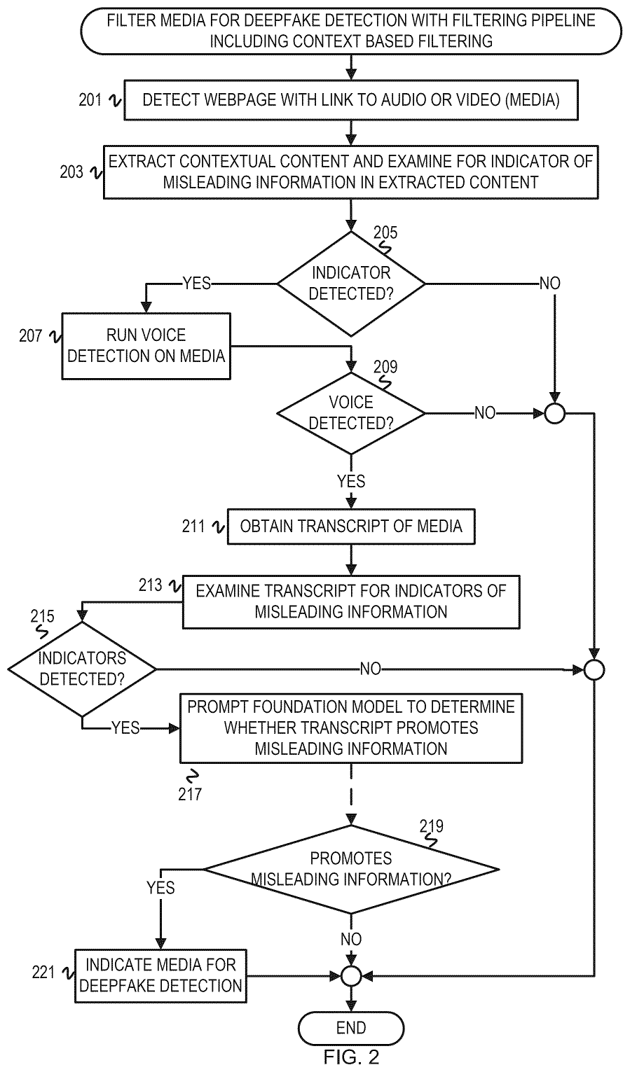

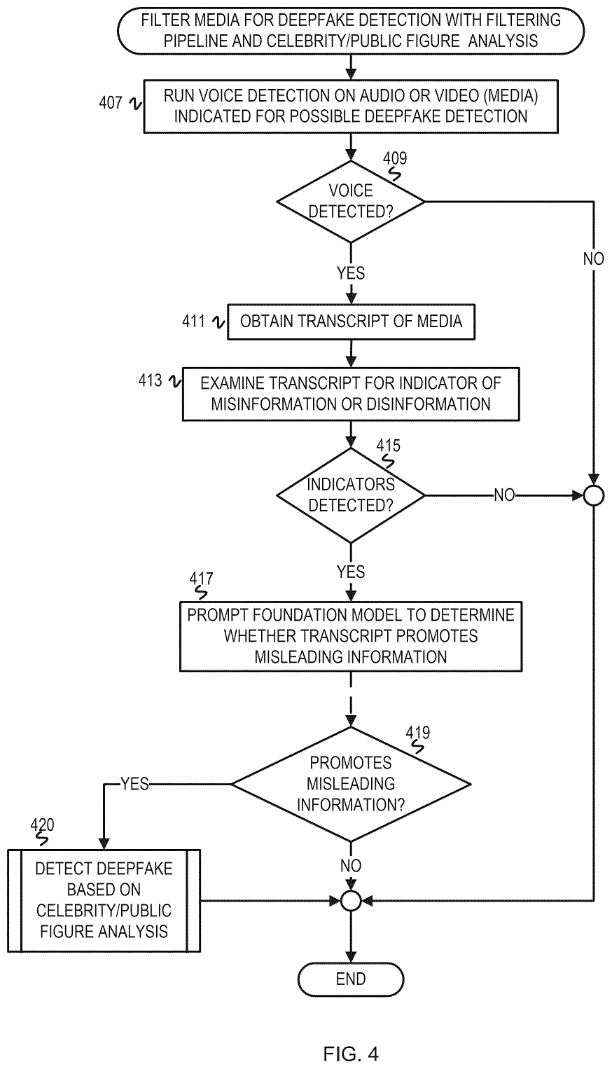

FIGS. 2-5 are flowcharts of example operations corresponding to multistage deepfake detection filtering. FIGS. 2-4 are flowcharts for different deepfake detection filtering pipelines. FIG. 4 is a flowchart for leveraging the filtering pipeline and celebrity detection for deepfake detection. The example operations are described with reference to a deepfake detection filtering pipeline for consistency with the FIG. 1 and ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for filtering media for deepfake detection with a filtering pipeline that includes context based filtering. The context-based filtering is the first filtering operation that relies on content that gives context for the media. As mentioned previously, this contextual content can be metadata (e.g., tags, descriptive text for a webpage section or object in the webpage source code), rendered or to be rendered text or images proximate to the media or media link (or simply on the same web page), infrastructure data (e.g., a domain name), and/or URL query parameters.

At block 201, the deepfake detection filtering pipeline detects a webpage with embedded or linked video or audio media. For instance, a URL is provided to the deepfake detection filtering pipeline. The deepfake detection filtering pipeline retrieves the corresponding webpage.

At block 203, the deepfake detection filtering pipeline extracts contextual content from rendered content of the webpage and/or source code of the webpage. The deepfake detection filtering pipeline examines the extracted content for indicators of misleading information. The deepfake detection filtering pipeline can examine different types of contextual content with different examination rules. For instance, the deepfake detection filtering pipeline can search the source code (e.g., image tags, section text, etc.) and URL query parameters for keywords correlated with misleading information scans or campaigns (e.g., financial scam related keywords). The list of keywords can be updated to include current topic keywords (e.g., changing political topics, personas, or changing financial scam keywords). The deepfake detection filtering pipeline can also examine the domain name of the webpage URL and/or media URL or any available hypertext transfer protocol (HTTP) message header data for infrastructure related data (e.g., Internet Protocol (IP) addresses, user-agent strings, etc.) correlated with malicious actors or misleading information campaigns. Embodiments can instead use a machine learning model trained to classify context as misleading or related to misleading information based on training data including labeled embeddings generated from articles, webpages, etc.

The textual content can be converted into embeddings with an embedding model (e.g., using doc2vec or word2vec). Embodiments may use both keyword matching and a trained machine learning model. If either keyword searching or the trained machine learning model indicates contextual content relates to misleading information, then the media is not filtered out. Embodiments can also utilize contextual data that relates to infrastructure. For example, media can be filtered based on domain name. A feature of a domain name (e.g., registration age based on domain name system (DNS) records or reputation) can be treated as an indicator of deepfake likelihood or promoting misleading information. Thus, an implementation can use a combination of these techniques and filter out media if no misleading information keyword is detected, if a trained machine learning model does not classify a webpage delivering the media as promoting misleading information, and the domain feature is not suspicious or risky.

At block 205, the deepfake detection filtering pipeline determines whether an indicator of misleading information was detected in the contextual content. This could be a keyword match, topic or sentiment match if a NLP technique is used, or a partial path or sub-path match for an infrastructure type of indicator. For instance, an infrastructure type of deepfake indicator would be a URL, either for the webpage delivering the media or a link to the media, that matches a regular expression “example[.]malicious[.]finances” or “example2[crypto]. cc”. If a misleading information indicator is detected, then operational flow proceeds to block 207. If not, then the media is filtered out from deepfake detection and operational flow ends.

At block 207, the deepfake detection filtering pipeline runs voice detection on the media. The deepfake detection filtering pipeline can pass the media as an argument to a voice detection application/service or run an internal voice detection. If the media is video, the deepfake detection filtering pipeline may extract the audio and submit the extracted audio for voice detection.

At block 209, the deepfake detection filtering pipeline determines whether a voice was detected in the audio. The deepfake detection filtering pipeline can impose a condition that a voice was detected for at least a defined threshold of time, for example 10 seconds. In some cases, the audio analysis can distinguish between an authentic human voice and a synthesized voice. This information can be used in aggregate with other criteria (e.g., do not filter out if less than 10 seconds but a synthesized voice is detected) or added as an annotation if the media is filtered out. If the deepfake detection filtering pipeline determines that a voice detection criterion is satisfied, then operational flow proceeds to block 211. Otherwise, the media is filtered out from deepfake detection and operational flow ends.

At block 211, the deepfake detection filtering pipeline obtains a transcript of the media. Either the media or extracted audio is submitted for transcription. Similar to voice detection, this can be run locally/internally with respect to the deepfake detection filtering pipeline or an external service can be used.

At block 213, the deepfake detection filtering pipeline examines the transcript for indicators of misleading information. At this stage, the indicator is topic. The deepfake detection filtering pipeline determines topics of the transcript. The deepfake detection filtering pipeline uses NLP to detect one or more topics in the transcript. The deepfake detection filtering pipeline then determines whether the detected topic(s) match to any of a list of topics associated with promoting misleading information. In addition, the deepfake detection filtering pipeline can use a trained classifier to classify the transcript as misleading or promoting misleading information based on topics detected in the transcript. Raw training data including text (e.g., documents, articles, transcripts) can be processed to detect topics and vectors generated based on the topics labeled as misleading.

At block 215, the deepfake detection filtering pipeline determines whether an indicator of misleading information was detected in the transcript or the transcript was classified as promoting misleading information. As examples, the deepfake detection filtering pipeline determines whether a keyword was matched, a sufficient confidence value was output from a classifier, or a semantic embedding of the transcript is within a threshold distance from a centroid of a misleading information cluster. If the deepfake detection filtering pipeline detects an indicator of misleading information in the transcript, then operational flow proceeds to block 217. Otherwise, the media is filtered out from deepfake detection and operational flow ends for the media.

At block 217, the deepfake detection filtering pipeline prompts a foundation model to determine whether the media promotes misleading information based on the transcript. A prompt is constructed with a task instruction for the model to determine whether the transcript promotes or helps to promote a scam or misleading information and with the transcript incorporated into the prompt. The prompt can include additional task instructions or context. For instance, the prompt can include examples of misleading information scams or campaigns, such as giveaways, endorsements, or election related misleading information. The prompt can also include task instructions to identify a topic and/or summarize the transcript. The prompt can also be constructed with a task instruction for the model to generate its answer/output according to a specified format, such as a structured object of key-value pairs. For example, the prompt can instruct the model to format its outputs as follows:
“topic”: {a 1-2 word description of the topic of the transcript},
“summary”: The transcript is about {topic}.{summarize the transcript},
“scam classification”: {Yes/No, Indicate Yes if this transcript promotes or helps to promote scams, deception, or fraud},
“explanation”: {Provide an explanation for your answer of whether the transcript promotes or helps to promote a scam, fraud, or deception.},
“celebrity”: {List out any celebrities or public figures identified in the transcript, separated by a colon.}.

At block 219, the deepfake detection filtering pipeline determines whether the foundation model responded that the transcript promotes misleading information. A dashed line from block 217 to block 219 represents the asynchronous flow between prompting a model and receiving a response from the model. If the response indicates that the transcript promotes misleading information then operational flow proceeds to block 221. Otherwise, the media is filtered out from deepfake detection and the operational flow ends for the media. Implementations can annotate or associate an indication that the media is suspicious even if filtered out from deepfake detection since the media has sufficient indicators of misleading information to arrive at the last filtering stage. Implementations can associate indicators corresponding to different degrees of suspicion depending on the stage at which media is filtered out from deepfake detection. These marked media and webpages can be analyzed later.

At block 221, the deepfake detection filtering pipeline indicates the media for deepfake detection. The deepfake detection filtering pipeline can pass the media or a reference to the media to a deepfake detection service or program. In some cases, such as URL filtering, the deepfake detection filtering pipeline can accumulate media to pass as a batch for deepfake detection.

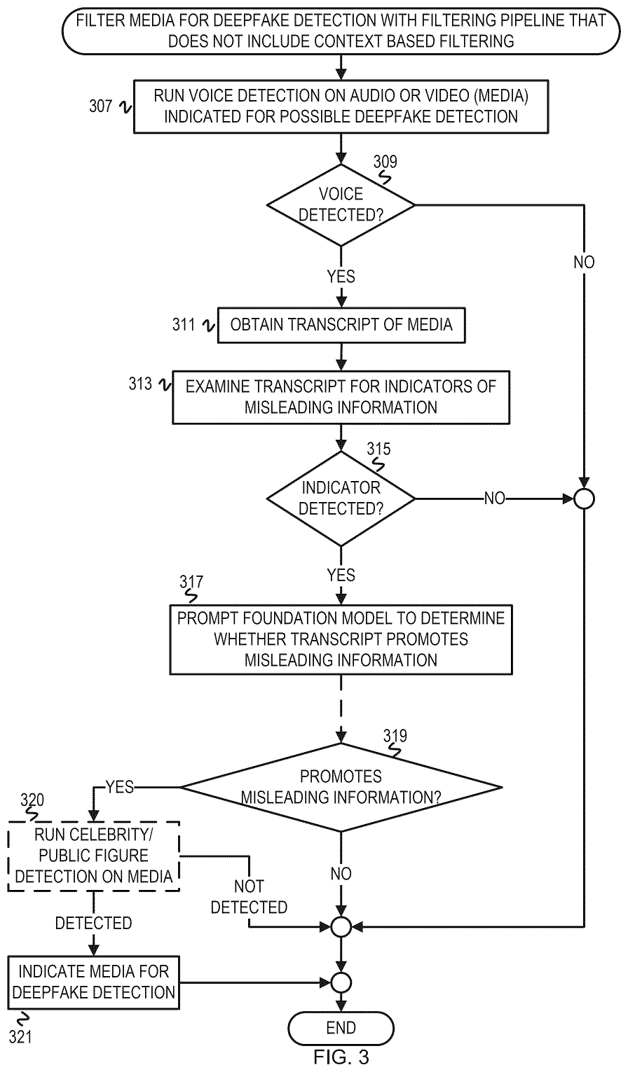

FIG. 3 is a flowchart of example operations for filtering media for deepfake detection with a filtering pipeline that does not include context based filtering. Embodiments can eschew the context based filtering and begin with filtering based on voice detection. In some cases, contextual data may not be available to analyze, such as when filtering standalone media or media that lacks context data.

The example operations of FIG. 3 are substantially similar to the operations of FIG. 2. Therefore, elaborative text that would be redundant is not repeated. At block 307, the deepfake detection filtering pipeline runs voice detection on media indicated for deepfake detection. At block 309, the deepfake detection filtering pipeline determines whether a voice was detected in the audio. If the deepfake detection filtering pipeline determines that a voice detection criterion is satisfied, then operational flow proceeds to block 311. Otherwise, the media is filtered out from deepfake detection and operational flow ends. At block 311, the deepfake detection filtering pipeline obtains a transcript of the media. At block 313, the deepfake detection filtering pipeline examines the transcript for indicators of misleading information. At block 315, the deepfake detection filtering pipeline determines whether an indicator of misleading information was detected in the transcript. If the deepfake detection filtering pipeline detects an indicator of misleading information in the transcript, then operational flow proceeds to block 317. Otherwise, the media is filtered out from deepfake detection and operational flow ends for the media. At block 319, the deepfake detection filtering pipeline determines whether the foundation model responded that the transcript promotes misleading information. If the response indicates that the transcript promotes misleading information then operational flow proceeds to block 320. Otherwise, the media is filtered out from deepfake detection and the operational flow ends for the media.

At block 320, the deepfake detection filtering pipeline runs celebrity/public figure detection on the media. For instance, the deepfake detection filtering pipeline passes the media to a service or program that performs the celebrity/public figure detection. The detection is based on voice recognition for audio and based on voice and/or facial recognition for video. The celebrity/public figure detection can return a binary answer and/or a name of a detected celebrity/public figure. The detection of a celebrity/public figure further increases the likelihood that the media is a deepfake. Media that promotes misleading information without a celebrity/public figure may not be considered a deepfake since it lacks the influence of a celebrity/public figure. Block 320 is depicted in a dashed line to indicate that is an optional operation in FIG. 3 and could be an optional operational in FIG. 2 after block 219. If a celebrity/public figure is not detected, then operational flow ends and the media is filtered out from deepfake detection. Otherwise, operational flow proceeds to block 321. At block 321, the deepfake detection filtering pipeline indicates the media for deepfake detection.

FIG. 4 is a flowchart of example operations for filtering media for deepfake detection with a filtering pipeline that uses celebrity/public figure analysis for deepfake detection. The example operations of FIG. 4 proffer a celebrity/public figure analysis as a substitute for deepfake detection. Since celebrity/public figure detection is still costly, the filtering pipeline can precede the celebrity/public figure analysis.

The example operations of FIG. 4 are substantially similar to the operations of FIGS. 2 and 3 with the exception of block 420. Therefore, elaborative text that would be redundant is not repeated. At block 407, the deepfake detection filtering pipeline runs voice detection on media indicated for deepfake detection. At block 409, the deepfake detection filtering pipeline determines whether a voice was detected in the audio. If the deepfake detection filtering pipeline determines that a voice detection criterion is satisfied, then operational flow proceeds to block 411. Otherwise, the media is filtered out from deepfake detection and operational flow ends. At block 411, the deepfake detection filtering pipeline obtains a transcript of the media. At block 413, the deepfake detection filtering pipeline examines the transcript for indicators of misleading information. At block 415, the deepfake detection filtering pipeline determines whether an indicator of misleading information was detected in the transcript. If the deepfake detection filtering pipeline detects an indicator of misleading information in the transcript, then operational flow proceeds to block 417. Otherwise, the media is filtered out from deepfake detection and operational flow ends for the media. At block 419, the deepfake detection filtering pipeline determines whether the foundation model responded that the transcript promotes misleading information. If the response indicates that the transcript promotes misleading information then operational flow proceeds to block 420. Otherwise, the media is filtered out from deepfake detection and the operational flow ends for the media.

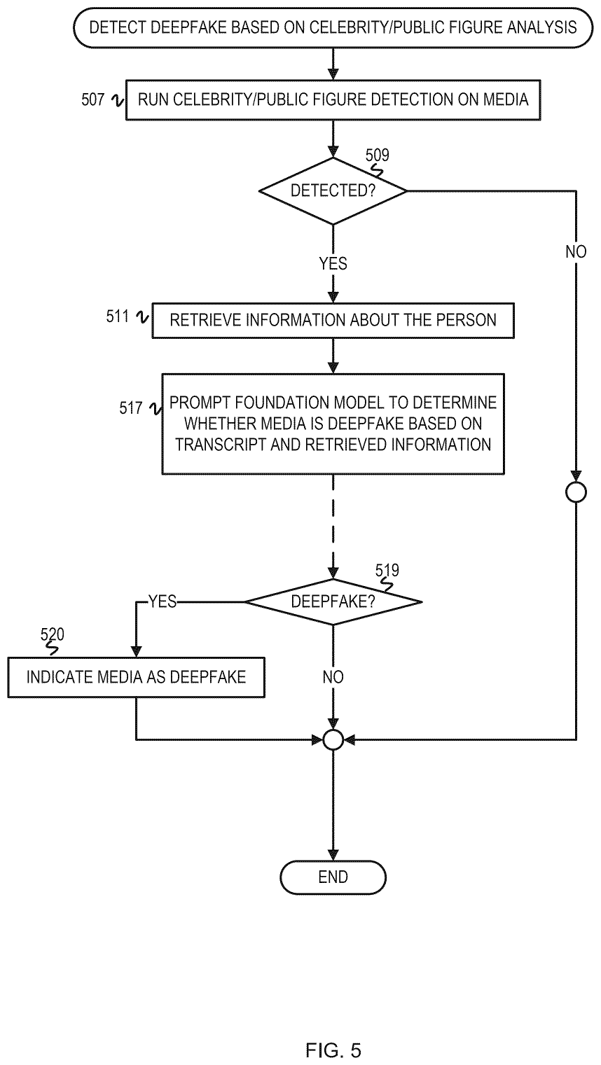

At block 420, the deepfake detection filtering pipeline runs celebrity/public figure analysis as a proxy for more complex deepfake detection. Instead of submitting the media for deepfake detection if a celebrity/public figure is identified in the media, detection of a celebrity/public figure after the previous filtering operations is treated as detection of a deepfake. FIG. 5 provides example operations that elaborate on the analysis.

FIG. 5 is a flowchart of example operations for celebrity/public figure analysis for deepfake detection. The example operations provide an analysis that is a less costly alternative to the more computationally expensive deepfake detection. The example operations effectively treat the detection of a celebrity/public figure as high confidence indicator that the media is a deepfake.

At block 507, the deepfake detection filtering pipeline runs celebrity/public figure detection on the media. Similar to block 320, the deepfake detection filtering pipeline passes the media to a program or service that performs celebrity/public figure detection. For this illustration, a binary response would be insufficient. The analysis relies on a name of the detected celebrity/public figure being reported.

At block 509, the deepfake detection filtering pipeline determines whether a celebrity/public figure is detected in the media (i.e., whether a name is returned). If so, then operational flow proceeds to block 511. If not, then operational flow for the media ends.

At block 511, the deepfake detection filtering pipeline retrieves information about the person detected. The deepfake detection filtering pipeline can query a repository or specified website to retrieve information about the identified person.

At block 517, the deepfake detection filtering pipeline prompts a foundation model to determine whether the media is a deepfake based on the transcript of the media and the retrieved information about the person. A prompt can be constructed that includes a task instruction for the foundation model to determine whether the identified person is being used in a scam or to promote misleading information with the person's retrieved information included as context. An example prompt is provided below.
You will be provided a transcript of audio or video and information about a person, who is {name}. The audio or video presents {name} as the speaker or one of the speakers in the transcript. Based on the transcript and the information about the person, determine whether {name} is actually a speaker in the transcript or if this is an impersonation or manipulation. Generate your answer according to the following format.
“Deepfake”: {Yes/No, Answer yes if you determine that {name} is most likely not one of the speakers in the transcript. Answer no if you have high confidence that {name} is a speaker in the transcript.}

At block 519, the deepfake detection filtering pipeline determines whether the response from the foundation model indicates that the media is a deepfake. A dashed line from block 517 to block 519 represents the asynchronous flow between prompting a model and receiving a response from the model. If the response from the model indicates that the media is a deepfake, then operational flow proceeds to block 520. Otherwise, operational flow ends for the media.

At block 520, the deepfake detection filtering pipeline indicates the media as a deepfake. The deepfake detection filtering pipeline can include metadata (e.g., a tag) or a notification that specifies the classification of deepfake is based on the celebrity/public figure analysis and not the computationally expensive deepfake detection.

### Variations

The example illustrations refer to a few different deployment scenarios for the deepfake detection filtering pipeline. These examples should not be used to limit scope of the claims or use of the technology. For instance, the deepfake detection filtering pipeline could be “inline” or activated on streaming media, such as online audio or video meetings. The deepfake detection filtering pipeline could accumulate sufficient contextual data and/or audio and then begin the analysis and continue the accumulation and filtering at intervals spaced for sufficient data to be gathered.

The example illustrations disclosed using keywords for filtering, but embodiments can also create a feedback mechanism between results of deepfake detection and the keywords. For example, topical keywords can be extracted from contextual data of media indicated as deepfake and added to the keywords in the context based filtering or the transcript filtering. In addition, infrastructure data used for matching or partial matching can be expanded upon. For example, a domain name of path of a URL of a deepfake can be used to expand the scope of infrastructure matching by pruning child paths already used for filtering.

In addition, the example illustrations described the use of misleading information indicators in terms that included keyword searching and topic detection. Implementations that supplement matching keywords or topics with machine-learning classification or implementations that do not employ machine learning classification, can use criteria more than determining whether a keyword or topic matches an entry in a listing. For instance, a minimum number of matches can be set and weights can be assigned to different keywords or topics. If the sum of the weights does not satisfy a threshold, then the media would be filtered out.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

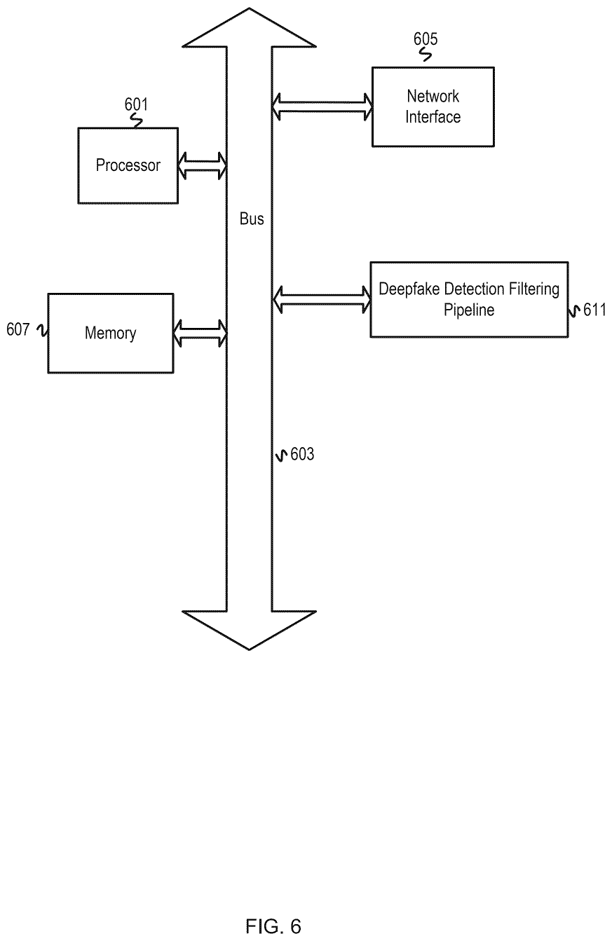

FIG. 6 depicts an example computer system with a deepfake detection filtering pipeline. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes deepfake detection filtering pipeline 611. The deepfake detection filtering pipeline 611 successively examines and filters video or audio media to determine whether to run deepfake detection on the media. The deepfake detection filtering pipeline 611 begins with lightweight filtering based on context around the media (e.g., context in a delivering webpage), although embodiments may forgo this initial lightweight filtering. The deepfake detection filtering pipeline 611 then filters based on voice detection. If a voice is detected for a sufficient amount of time, a transcript of the audio is generated and used for filtering based on detection of keywords or subject matter that has been correlated with misleading information attacks or campaigns. For media that is not yet filtered out, the deepfake detection filtering pipeline 611 prompts a foundation model to determine whether the transcript is promoting misleading information or helping to mount a deceptive/fraudulent attack or campaign. The deepfake detection filtering pipeline 611 then runs deepfake detection on the media dependent on the answer/response from the foundation model. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
determining whether deepfake detection should be run on a first digital media, wherein determining whether deepfake detection should be run comprises, determining whether a human voice is present in the first digital media;
based on determining that a human voice is present, obtaining a transcript of the first digital media;
determining whether the transcript includes a topic corresponding to misleading information;
filtering out the first digital media from deepfake detection if the transcript does not include a topic corresponding to misleading information;
based on the first digital media not being filtered out for deepfake detection, prompting a foundation model to determine whether the transcript promotes misleading information; and
indicating that deepfake detection should be run on the first digital media based on the foundation model indicating the transcript promotes misleading information.

2. The method of claim 1, wherein determining whether deepfake detection should be run on the first digital media further comprises:
analyzing contextual data of the first digital media to determine whether the contextual data includes a keyword or topic corresponding to misleading information;
based on a determination that the contextual data does not include a keyword or topic corresponding to misleading information, filtering out the first digital media from deepfake detection; and
based on a determination that the contextual data include a keyword or topic corresponding to misleading information, downloading the first digital media, wherein determining whether a human voice is present in the first digital media is after downloading the first digital media.

3. The method of claim 2, wherein analyzing contextual data of the first digital media comprises analyzing at least one of a uniform resource locator (URL) for the first digital media, text on a webpage that includes the URL of the first digital media, metadata of the first digital media, a URL of the webpage that includes the URL of the first digital media, a feature of a domain name in the URL, and source code of the webpage that includes the URL of the first digital media.

4. The method of claim 2, wherein analyzing the contextual data comprises at least one of searching the contextual data for at least one of a first set of keywords correlated with misleading information, generating a feature vector from the contextual data and inputting the feature vector into a machine learning model that has been trained to classify input as misleading, determining whether a feature of a domain name of the first digital media is suspicious, and prompting the foundation model or another foundation model to determine whether the contextual data is suspicious.

5. The method of claim 1, wherein determining whether the transcript includes a keyword or a topic corresponding to misleading information comprises at least one of:
searching the transcript for at least one of a first set of keywords correlated with misleading information;
prompting the foundation model or another foundation model to determine a topic of the transcript and then determining whether the determined topic corresponds to misleading information; and
generating a feature vector from the transcript and inputting the feature vector into a machine learning model that has been trained to classify input as misinformation.

6. The method of claim 1, wherein determining whether deepfake detection should be run on the first digital media further comprises running celebrity detection on the first digital media after the foundation model responds that the transcript prompts misleading information and filtering out the first digital media if a celebrity is not detected.

7. The method of claim 1 further comprising:
based on detection of the first digital media as a deepfake, extracting at least one of a keyword and infrastructure information of the first digital media, wherein the infrastructure information identifies a host of the first digital media; and
indicating the extracted keyword and/or extracted infrastructure information as correlated with misleading information and for analysis of subsequent transcripts.

8. A non-transitory, machine-readable medium having program code stored thereon, the program code comprising instructions to:
successively determine whether to filter out a first digital media from deepfake detection, wherein the instructions to successively determine whether to filter out the first digital media comprise instructions to,
determine whether a human voice is present in the first digital media and filter out the first digital media if a human voice is not present;
obtain a transcript of the first digital media if a human voice is present;
determine whether the transcript indicates a topic or includes a keyword corresponding to misleading information and filter out the first digital media from deepfake detection if the transcript does not indicate a topic or does not include a keyword corresponding to misleading information;
based on the first digital media not being filtered out for deepfake detection, prompt a foundation model to determine whether the transcript promotes misleading information and filter out the first digital media from deepfake detection if the foundation model responds that the transcript does not promote misleading information; and
indicate that deepfake detection should be run on the first digital media based on a determination that the first digital media should not be filtered out.

9. The non-transitory, machine-readable medium of claim 8, wherein the instructions to determine whether deepfake detection should be run on the first digital media comprises instructions to:
analyze contextual data of the first digital media to determine whether the contextual data includes a keyword or indicates a topic corresponding to misleading information and filter out the first digital media from deepfake detection based on a determination that the contextual data does not include a keyword or indicate a topic corresponding to misleading information; and
based on a determination that the contextual data include a keyword or indicates a topic corresponding to misleading information, downloading the first digital media, wherein the instructions to determine whether a human voice is present in the first digital media is after downloading the first digital media.

10. The non-transitory, machine-readable medium of claim 9, wherein the instructions to analyze contextual data of the first digital media comprise instructions to analyze at least one of a uniform resource locator (URL) for the first digital media, text on a webpage that includes the URL of the first digital media, metadata of the first digital media, a URL of the webpage that includes the URL of the first digital media, a feature of a domain name of the first digital media, and source code of the webpage that includes the URL of the first digital media.

11. The non-transitory, machine-readable medium of claim 9, wherein the instructions to analyze the contextual data comprise at least one of instructions to search the contextual data for at least one of a first set of keywords correlated with misleading information, instructions to generate a feature vector from the contextual data and input the feature vector into a machine learning model that has been trained to classify input as misleading, determine whether a feature of a domain name of the first digital media is suspicious, and instructions to prompt the foundation model or another foundation model to determine whether the contextual data is suspicious.

12. The non-transitory, machine-readable medium of claim 8, wherein the instructions to determine whether the transcript includes a keyword or indicates a topic corresponding to misleading information comprises at least one of:
instructions to search the transcript for at least one of a first set of keywords correlated with misleading information;
instructions to prompt the foundation model or another foundation model to determine a topic of the transcript and to determine whether the determined topic corresponds to misleading information; and
instructions to generate a feature vector from the transcript and input the feature vector into a machine learning model that has been trained to classify input as misleading.

13. The non-transitory, machine-readable medium of claim 8, wherein the instructions to successively determine whether to filter out the first digital media further comprise instructions to run celebrity detection on the first digital media after the foundation model responds that the transcript promotes misleading information and to filter out the first digital media from deepfake detection if a celebrity is not detected.

14. The non-transitory, machine-readable medium of claim 8, wherein the program code further comprises instructions to:
based on detection of the first digital media as a deepfake, extract at least one of a keyword and infrastructure information of the first digital media, wherein the infrastructure information identifies a host of the first digital media; and
indicate the extracted keyword and/or extracted infrastructure information as correlated with misleading information and indicate the extracted keyword and/or infrastructure information for analysis of subsequent transcripts.

15. An apparatus comprising:
a processor; and
a machine-readable medium having stored thereon instructions executable by the processor to cause the apparatus to,
determine whether to filter out a first digital media from deepfake detection, wherein the instructions to determine whether to filter out the first digital media comprise instructions to,
determine whether a human voice is present in the first digital media and filter out the first digital media if a human voice is not present;
obtain a transcript of the first digital media if a human voice is present;
determine whether the transcript indicates a topic corresponding to misleading information and filter out the first digital media from deepfake detection if the transcript does not indicate a topic corresponding to misleading information;
based on the first digital media not being filtered out for deepfake detection,
determine whether a celebrity can be identified from the first digital media and the transcript;
retrieve a description of the celebrity if a celebrity was identified from the first digital media and the transcript; and
prompt a foundation model to indicate likelihood that the identified celebrity is likely to be used in a deepfake based, at least partly, on the transcript and the description of the celebrity;
indicate the first digital media as a malicious deepfake if the first digital media was not filtered out from deepfake detection and the foundation model indicated that the identified celebrity is likely being used in a malicious deepfake after a determination that the transcript indicates or includes a keyword corresponding to misleading information; and
indicate that deepfake detection should be run on the first digital media if the first digital media has not been filtered out or is not already indicated as a malicious deepfake.

16. The apparatus of claim 15, wherein the machine-readable medium further has stored thereon instructions executable by the processor to cause the apparatus to prompt the foundation model or another foundation model to determine whether the transcript promotes misleading information and to filter out the first digital media from deepfake detection if a response indicates that the transcript does not promote misleading information.

17. The apparatus of claim 15, wherein the instructions to prompt a foundation model to indicate likelihood that the identified celebrity is likely to be used in a deepfake based, at least partly, on the transcript and the description of the celebrity comprises the instruction being executable by the processor to cause the apparatus to build a prompt that includes the transcript, a name of the identified celebrity, and the description of the identified celebrity.

18. The apparatus of claim 15, wherein the machine-readable medium further has stored thereon instructions executable by the processor to cause the apparatus to:
based on indication of the first digital media as a malicious deepfake, extract at least one of a keyword and infrastructure information of the first digital media, wherein the infrastructure information identifies a host of the first digital media; and
indicate the extracted keyword and/or extracted infrastructure information as correlated with misleading information and indicate the extracted keyword and/or infrastructure information for analysis of subsequent digital media suspected of being a deepfake.

19. The apparatus of claim 15, wherein the instructions to determine whether the transcript indicates a topic corresponding to misleading information comprise at least one of:
instructions to detect one or more topics in the transcript and then determine whether the one or more detected topics matches a topic indicated as corresponding to misleading information;
instructions to prompt the foundation model or another foundation model to determine a topic of the transcript and to determine whether the determined topic corresponds to misleading information; and
instructions to generate a feature vector from the transcript and input the feature vector into a machine learning model that has been trained to classify input as misleading.

20. The apparatus of claim 15, wherein the instructions to determine whether to filter out a first digital media from deepfake detection comprise instructions to:
analyze contextual data of the first digital media to determine whether the contextual data includes a keyword or indicates a topic corresponding to misleading information and filter out the first digital media from deepfake detection based on a determination that the contextual data does not include a keyword or indicate a topic corresponding to misleading information; and
based on a determination that the contextual data include a keyword or indicates a topic corresponding to misleading information, downloading the first digital media, wherein the instructions to determine whether a human voice is present in the first digital media is after downloading the first digital media.
